(19) United States
(12) Patent Application Publication
(10) Pub. No.: US 2026/0111118 A1
(43) Pub. Date: Apr. 23, 2026

(54) MANAGING MULTI-RANK OPERATIONS IN MEMORY SYSTEMS

(71) Applicant: Macronix International Co., Ltd., Hsinchu (TW)

(72) Inventors: Che-Chuan Liu, Taoyuan (TW); Chun-Yi Lee, Hsinchu (TW)

(73) Assignee: Macronix International Co., Ltd., Hsinchu (TW)

(21) Appl. No.: 19/256,865

(22) Filed: Jul. 1, 2025

Related U.S. Application Data
(60) Provisional application No. 63/710,635, filed on Oct. 23, 2024.

(51) Int. Cl. G06F 3/06

(52) U.S. Cl. CPC G06F 3/0613; G06F 3/0659; G06F 3/0673

(57) ABSTRACT

Systems, methods, apparatus, and devices for performing multi-rank operations are provided. An example apparatus includes a plurality of ranks. Each of the plurality of ranks includes at least one memory device. One or more first ranks of a plurality of first ranks of the plurality of ranks are configured to be enabled based on one or more first signals. The plurality of first ranks are configured to be selected based on a second signal that is different from the one or more first signals. The one or more first ranks are configured to perform one or more first operations in response to receiving the one or more first signals and the second signal.

### CROSS-REFERENCE TO RELATED APPLICATION

This Application claims the benefit of U.S. Provisional Patent Application No. 63/710,635, filed Oct. 23, 2024, which is incorporated by reference herein in its entirety.

### TECHNICAL FIELD

The present disclosure is directed to memory systems, e.g., memory systems including multiple ranks.

### BACKGROUND

A memory system can include multiple ranks, with each rank having one or more memory devices. One or more ranks in the multiple ranks can handle data transfer using a common channel, while other ranks in the multiple ranks can handle data transfer using other channels. The one or more ranks coupled to the common channel can be operated one rank at a time.

### SUMMARY

The present disclosure describes systems, devices, methods, and techniques for managing multi-rank operations in memory systems, e.g., a memory system including multiple memory devices such as dynamic random-access memories (DRAMs) such as synchronous dynamic random-access memories (SDRAMs), solid-state drives (SSDs), high-density drivers (HDDs), NAND flash modules, or a combination thereof.

One aspect of the present disclosure features an apparatus, including a plurality of ranks. Each of the plurality of ranks includes at least one memory device. One or more first ranks of a plurality of first ranks of the plurality of ranks are configured to be enabled based on one or more first signals. The plurality of first ranks are configured to be selected based on a second signal that is different from the one or more first signals. The one or more first ranks are configured to perform one or more first operations in response to receiving the one or more first signals and the second signal.

In some implementations, each of the plurality of first ranks is configured to receive the second signal, and each of the one or more first ranks is configured to receive a respective first signal of the one or more first signals.

In some implementations, each of the one or more first ranks includes an interface having a first pin for receiving the respective first signal and a second pin for receiving the second signal, the second pin being different from the first pin.

In some implementations, the interface of each of the one or more first ranks has one or more other pins including at least one of: a clock pin for receiving a clock signal, one or more data pins for transferring data from or to a memory cell array, a reset pin for resetting the first rank, a clock enable (CKE) pin for enabling the clock signal, a data mask inversion (DMI) pin, a command/address (CA) pin for receiving a command/address input, or a data strobe (DQS) pin for synchronizing a timing of data transmission.

In some implementations, the interface of each of the plurality of first ranks is coupled to a controller through corresponding pins, the corresponding pins including the first pin, the second pin, and the one or more other pins.

In some implementations, second pins of the plurality of first ranks are coupled together to receive the second signal, and first pins of a plurality of second ranks are independent from each other and configured to respectively receive corresponding first signals.

In some implementations, each of the plurality of first ranks is configured to: receive one or more other signals including a clock signal, a clock enable signal, a data signal, a data mask inversion (DMI) signal, a command/address (CA) signal, and a data strobe (DQS) signal. The one or more other signals are different from the second signal and the one or more first signals.

In some implementations, each of the one or more first ranks is configured to perform at least one of decoding the CA signal based on the second signal, synchronizing the CA signal based on the DQS signal and the clock signal, or operating a corresponding memory device of the rank based on the data signal and the CA signal.

In some implementations, the one or more first ranks are configured to: perform the one or more first operations sequentially, or perform the one or more first operations in parallel.

In some implementations, the one or more first operations include: a sequential operation including rank-specific training or data read out, or an in-parallel operation including computing or data inputting.

In some implementations, the second signal includes a higher signal level and a lower signal level that alternate over time, and each of the one or more first signals includes a step signal.

In some implementations, the plurality of first ranks are associated with a first channel, and the plurality of ranks include a plurality of second ranks that are associated with a second channel different from the first channel, and the plurality of second ranks are different from the plurality of first ranks.

In some implementations, the plurality of ranks are coupled to a controller, and the plurality of first ranks are configured to transfer data to or from the controller through the first channel, and where the plurality of second ranks are configured to transfer data to or from the controller through the second channel.

In some implementations, the plurality of ranks are configured to: receive the second signal by the plurality of first ranks to select the plurality of first ranks, without receiving a third signal to the plurality of second ranks to select the plurality of second ranks, and receive the third signal to the plurality of second ranks to select the plurality of second ranks, without receiving the second signal to the plurality of first ranks to select the plurality of first ranks.

In some implementations, each of the plurality of second ranks is configured to receive the third signal, one or more second ranks of the plurality of second ranks are configured to receive one or more fourth signals respectfully to enable the one or more second ranks, and each of the one or more second ranks is enabled to perform one or more second operations in response to receiving the third signal and a corresponding fourth signal of the one or more fourth signals.

Another aspect of the present disclosure features a memory device, including: a memory cell array and a peripheral circuit coupled to the memory cell array. The peripheral circuit includes an interface having a first pin and a second pin, the second pin being different from the first pin. The peripheral circuit is configured to: receive a first signal at the first pin to enable the memory device; receive a second signal at the second pin to select the memory device, where the second signal is different than the first signal; and in response to receiving the first signal and the second signal, enable the memory device to perform one or more operations on the memory cell array.

In some implementations, the interface further includes at least one of: a clock pin for receiving a clock signal, one or more data pins for transferring data from or to the memory cell array, a reset pin for resetting the memory device, a clock enable (CKE) pin for enabling the clock signal, a data mask inversion (DMI) pin, a command/address (CA) pin for receiving a command/address input, or a data strobe (DQS) pin for synchronizing a timing of data transmission.

In some implementations, the peripheral circuit is configured to receive the second signal to select the memory device, while the memory device is disabled.

In some implementations, the peripheral circuit is configured to: receive a command/address (CA) signal that is different from the first signal and the second signal; decode the CA signal based on the second signal; and perform the one or more operations on the memory cell array based on the CA signal.

Another aspect of the present disclosure features a method, including: receiving, by one or more first ranks of a plurality of first ranks of a plurality of ranks, one or more first signals to enable the one or more first ranks; receiving, by the plurality of first ranks, a second signal to select the plurality of first ranks, the second signal being different from the one or more first signals, where the one or more first ranks are enabled in response to receiving the one or more first signals and the second signal; and performing, by the one or more first ranks, one or more first operations.

Another aspect of the present disclosure features a memory system. The memory system includes multiple ranks and a circuitry coupled to the multiple ranks. Each of the multiple ranks includes at least one memory device. The circuitry is configured to transmit one or more first signals to one or more first ranks of multiple first ranks of the multiple ranks to enable the one or more first ranks, and transmit a second signal to the multiple first ranks to select the multiple first ranks. The second signal is different from the one or more first signals, and the one or more first ranks are enabled to perform one or more first operations in response to receiving the one or more first signals and the second signal. In some implementations, the memory system includes a memory controller coupled to the multiple ranks, and the memory controller includes the circuitry.

In some implementations, a number of the one or more first ranks is identical to or smaller than a number of the multiple first ranks.

In some implementations, the at least one memory device includes a synchronous dynamic random-access memory (SDRAM).

In some implementations, the second signal is transmitted to each of the multiple first ranks, and each of the one or more first ranks is configured to receive a respective first signal of the one or more first signals.

In some implementations, each of the one or more first ranks includes an interface having a first pin for receiving the respective first signal and a second pin for receiving the second signal, the second pin being different from the first pin.

In some implementations, the interface has one or more other pins including at least one of a clock pin for receiving a clock signal, one or more data pins for transferring data from or to the memory cell array, a reset pin for resetting the memory device, a clock enable (CKE) pin for enabling the clock signal, a data mask inversion (DMI) pin, a command/address (CA) pin for receiving a command/address input, or a data strobe (DQS) pin for synchronizing a timing of data transmission.

In some implementations, the circuitry includes multiple interface pins respectively coupled to corresponding pins of the interface of each of the multiple first ranks, the corresponding pins including the first pin, the second pin, and the one or more other pins.

In some implementations, second pins of the multiple first ranks are coupled together to receive the second signal, and first pins of the multiple second ranks are independent from each other and configured to respectively receive corresponding first signals.

In some implementations, the circuitry transmits one or more other signals including a clock signal, a clock enable signal, a data signal, a data mask inversion (DMI) signal, a command/address (CA) signal, and/or a data strobe (DQS) signal, to each of the multiple first ranks, where the one or more other signals are different from the one or more first signals and the second signal.

In some implementations, each of the one or more first ranks is configured to perform at least one of decoding the CA signal based on the first signal, synchronizing the CA signal based on the DQS signal and the clock signal, or operating a corresponding memory device of the rank based on the data signal and the CA signal.

In some implementations, the circuitry performs the one or more first operations sequentially on the one or more first ranks, or performs the one or more first operations in parallel on the one or more first ranks.

In some implementations, the one or more first operations include a sequential operation including rank-specific training or data read out, or an in-parallel operation including computing or data inputting.

In some implementations, the second signal includes a higher signal level and a lower signal level that alternate over time, and each of the one or more first signals includes a step signal.

In some implementations, the multiple first ranks are associated with a first channel, and the multiple ranks include multiple second ranks that are associated with a second channel different from the first channel, and the multiple second ranks are different from the multiple first ranks, and are coupled to the circuitry.

In some implementations, the circuitry transfers data to or from the multiple first ranks through the first channel.

In some implementations, the circuitry transfers data to or from the multiple second ranks through the second channel.

In some implementations, the circuitry transmits the second signal to the multiple first ranks to select the multiple first ranks, without transmitting a third signal to the multiple second ranks to select the multiple second ranks.

In some implementations, the circuitry transmits the third signal to the multiple second ranks, without transmitting the first signal to the multiple first ranks.

In some implementations, the circuitry transmits the third signal to each of the multiple second ranks.

In some implementations, the circuitry transmits one or more fourth signals respectfully to one or more second ranks of the multiple second ranks to enable the one or more second ranks, where each of the one or more second ranks is enabled to perform one or more second operations in response to receiving the third signal and a corresponding fourth signal of the one or more fourth signals.

In some implementations, the circuitry is coupled to a host device, and the circuitry receives the second signal from the host device to select the multiple first ranks to connect with the host device through a first channel.

In some implementations, the circuitry receives the one or more first signals from the host device to enable the one or more first ranks for the one or more first operations.

Another aspect of the present disclosure features a memory device. The memory device includes a memory cell array and a peripheral circuit coupled to the memory cell array. The peripheral circuit includes an interface having a first pin and a second pin, the second pin being different from the first pin. The peripheral circuit is configured to receive a first signal at the first pin to enable the memory device, receive a second signal at the second pin to select the memory device, where the second signal is different than the first signal, and in response to receiving the first signal and the second signal, enable the memory device to perform one or more operations on the memory cell array.

In some implementations, the interface further includes at least one of a clock pin for receiving a clock signal, one or more data pins for transferring data from or to the memory cell array, a reset pin for resetting the memory device, a clock enable (CKE) pin for enabling the clock signal, a data mask inversion (DMI) pin, a command/address (CA) pin for receiving a command/address input, or a data strobe (DQS) pin for synchronizing a timing of data transmission.

In some implementations, the peripheral circuit is configured to receive the second signal to select the memory device, while the memory device is disabled.

In some implementations, the peripheral circuit is configured to receive a command/address (CA) signal that is different from the first signal and the second signal, decode the CA signal based on the second signal, and perform the one or more operations on the memory cell array based on the CA signal.

In some implementations, the first signal includes alternating higher levels and lower levels, and the second signal includes a step signal from a lower level to a higher level or from a higher level to a lower level.

Another aspect of the present disclosure features a method. The method includes transmitting one or more first signals to one or more first ranks of multiple first ranks of multiple ranks of a memory system to enable the one or more first ranks, transmitting a second signal to the multiple first ranks to select the multiple first ranks, where the second signal is different from the one or more first signals, and the one or more first ranks are enabled in response to receiving the one or more first signals and the second signal, and performing one or more first operations on the one or more first ranks.

Another aspect of the present disclosure feature a method including: receiving, by one or more first ranks of a plurality of first ranks of a plurality of ranks, one or more first signals to enable the one or more first ranks; receiving, by the plurality of first ranks, a second signal to select the plurality of first ranks, the second signal being different from the one or more first signals, wherein the one or more first ranks are enabled in response to receiving the one or more first signals and the second signal; and performing, by the one or more first ranks, one or more first operations.

Implementations of the above techniques include methods, systems, computer program products and computer-readable media. In one example, a method can be performed by a memory system including multiple ranks and a memory controller coupled to the multiple ranks, and the method can include the above-described actions performed by the circuitry and the multiple ranks, e.g., the actions for managing multi-rank operations in the memory system. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1A is a schematic diagram of an example system including an example memory system that includes multiple ranks.

FIG. 1B is a schematic diagram of an example system including an example memory system that include multiple ranks corresponding to different channels.

FIG. 2 illustrates an example memory apparatus including multiple ranks.

FIG. 3 illustrates another example memory apparatus including multiple ranks in a same channel.

FIG. 4 illustrates an example memory device.

FIGS. 5A to 5C illustrate three example operations of enabling one or more ranks in a memory package to perform one or more operations.

FIG. 6 is a flowchart of an example process of managing multi-rank operations in a memory system.

Like reference numbers and designations in the various drawings indicate like elements. It is also to be understood that the various exemplary implementations shown in the figures are merely illustrative representations and are not necessarily drawn to scale.

### DETAILED DESCRIPTION

A multi-rank configuration defined by the Joint Electron Device Engineering Council (JEDEC) for Synchronous Dynamic Random-Access Memory (SDRAM) Standard specifies that each rank of multiple ranks coupled to a channel has its own chip select (CS) signal that can be used to select and enable the bank. In some cases, the CS signal of a rank coupled to a channel is independent of other CS signals of the ranks coupled to the same channel, while the command/address (CA) signals are shared among all ranks coupled to the same channel. Therefore, in the same channel coupled to multiple ranks, the timing relationships between the CS and the CA signals of each rank are independent. When ranks coupled to the same channel operate serially, a host coupled to the ranks can use the trained CS to CA timing to operate each rank coupled to the same channel. The trained CS to CA timing for each rank can be different, and therefore the host can only operate one rank in the same channel at a time.

In some cases, if the host operates multiple ranks coupled to the same channel simultaneously (e.g., during a multi-rank parallel operation), one set of CS to CA timing may not suffice for every rank coupled to the same channel. Therefore, the aforementioned configuration may not perform multi-rank parallel operation. One set of CS to CA timing may not meet the different CS to CA timing requirements of different ranks simultaneously, because the CS signals received by different ranks may have timing mismatches, which could lead to inconsistent command decoding results for each rank.

In some cases, due to computing needs and/or inputting the same data to different ranks, parallel operation of multiple ranks coupled to the same channel can significantly increase computing power and reduce data input efficiency. Implementations of the present disclosure provide techniques that allow the host to operate multi-rank configuration of a memory system either serially (for rank-specific training or data read out purpose) or in parallel (for computing or inputting the same data).

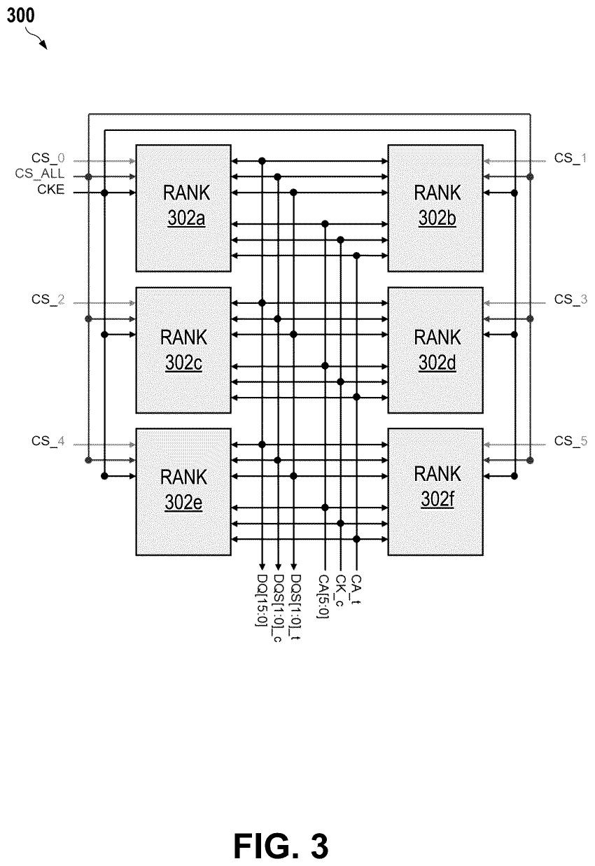

In some implementations, a rank select signal can be provided simultaneously to all ranks coupled to a same channel to select all the ranks for accessing by the host. A respective rank enable signal that is different than the rank select signal, can be provided to each of the ranks coupled to the same channel to enable each rank independently. By separating the rank select signal from the rank enable signals, one or more ranks in the full set of ranks coupled to the same channel can operate either sequentially or in parallel, depending on whether the one or more ranks receive their respective rank enable signals simultaneously. Therefore, in-parallel operations of the one or more ranks can be performed. Example operations of the one or more ranks are described with further details in FIGS. 3 to 6.

The techniques can be applied to various types of semiconductor devices, volatile memory devices, or non-volatile memory (NVM) devices, such as NAND flash memory, NOR flash memory, resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to two-dimensional (2D) memory devices or three-dimensional (3D) memory devices. The techniques can be applied to various memory types, such as SLC (single-level cell) devices, MLC (multi-level cell) devices like 2-level cell devices, TLC (triple-level cell) devices, QLC (quad-level cell) devices, or PLC (penta-level cell) devices. Additionally or alternatively, the techniques can be applied to various types of devices and systems, such as secure digital (SD) cards, embedded multimedia cards (eMMC), or solid-state drives (SSDs), embedded systems, among others. The techniques can be applied to SSDs or HDDs-based storage systems or all-flash arrays.

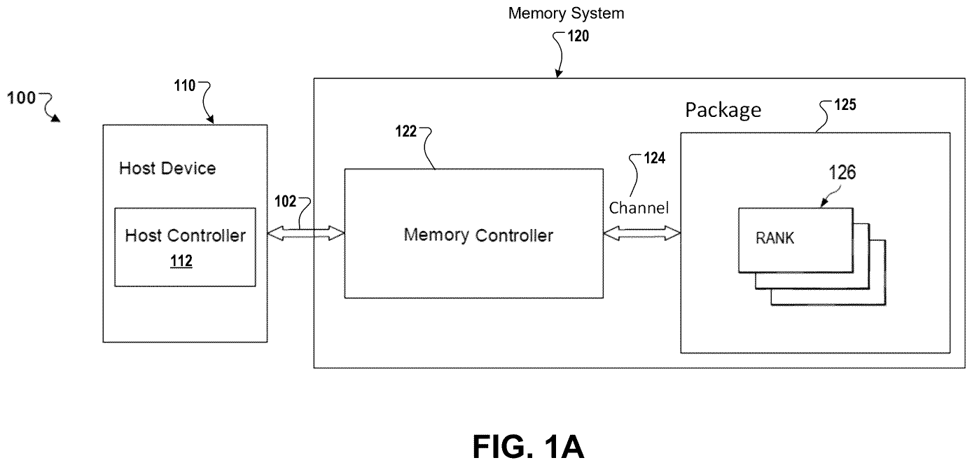

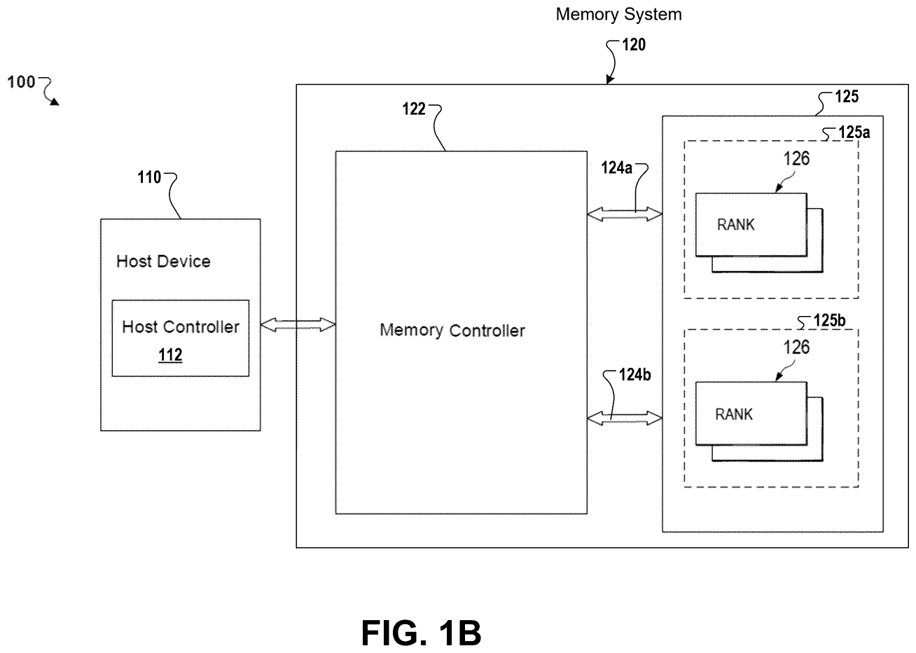

FIG. 1A is a schematic diagram of an example system 100 including a host (also referred to as a host device) 110 and an example memory system 120. The memory system 120 can include a memory controller 122 and a memory package 125 including a plurality of ranks 126 (referred to generally as ranks 126 and individually as rank 126). The memory controller 122 can be coupled to a communication bus 102, through which the memory controller 122 can communicate with host 110. In some examples, the communication bus 102 can be a Peripheral Component Interconnect Express (PCIE) based bus or a Serial Advanced Technology Attachment Express (SATA Express) based bus. In some implementations, the memory controller 122 and the host 110 communicate wirelessly or by wires.

In some implementations, the plurality of ranks 126 are integrated in the memory package 125. Each rank 126 can include one or more memory devices, and a memory device can be, e.g., a memory die such as an NAND flash memory die or an NOR flash memory die. The memory package 125 can be a memory chip or chiplet.

The memory controller 122 can be configured to manage data/command assignment among the ranks 126 in the memory package 125. For example, the memory controller 122 can receive data and a write command from the host 110 and store the data in one or more ranks 126. The memory controller 122 can also receive a read command from the host 110 to read data from one or more ranks 126.

The host 110 includes a host controller 112 that can include at least one processor and at least one memory coupled to the at least one processor and storing programming instructions for execution by the at least one processor to perform one or more corresponding operations. The memory controller 122 can include at least one memory and at least one processor configured to execute instructions and process data in at least one rank 126. The instructions can include firmware instructions and/or other program instructions that are stored as firmware code and/or other program code, respectively. The data includes program data corresponding to the firmware and/or other programs executed by the at least one processor, among other suitable data. In some implementations, the at least one processor is a general-purpose microprocessor, or an application-specific microcontroller, e.g., CPU, GPU, or DPU.

In some implementations, one or more ranks 126 can transfer data from or to the memory controller 122 through a common channel 124, e.g., as illustrated in FIG. 1A.

FIG. 1B is a schematic diagram of an example system 100 including an example memory system 120 that include multiple ranks corresponding to different channels. As shown in FIG. 1B, the memory package 125 can include multiple memory groups 125a, 125b. Each memory group 125a, 125b can include a plurality of ranks 126. Ranks 126 in a same memory group 125a, 125b are integrated in the memory group. The multiple memory groups 125a, 125b can be integrated in the memory package 125.

Each memory group 125a, 125b can be coupled to the memory controller 122 through a respective channel 124a, 124b, respectively. A first memory group 125a is coupled to the memory controller 122 through a first channel 124a, and a second memory group 125b is coupled to the memory controller 122 through a second channel 124b. The first and second channels 124a, 124b are different from each other. Ranks in a same memory group 125a, 125b are configured to transfer data from or to the memory controller 122 through the respective channel 124a, 124b.

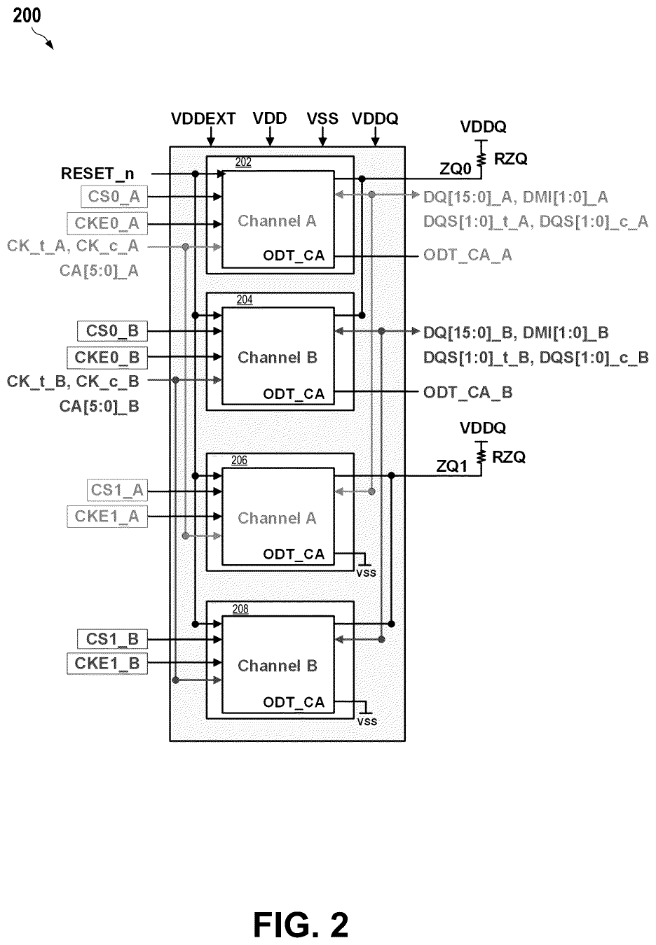

FIG. 2 illustrates an example memory apparatus 200 that can be an example of the memory package 125 of FIG. 1A or 1B or the memory group 125a or 125b of FIG. 1B. The example memory apparatus 200 includes four ranks 202, 204, 206, and 208. Each of the four ranks can be an example of the rank 126 in FIG. 1A or 1B. Channel A can be an example of the first channel 124a in FIG. 1B, and channel B can be an example of the second channel 124b in FIG. 1B. As shown in FIG. 2, ranks 202 and 206 are coupled to channel A, and ranks 204 and 208 are coupled to channel B. Each of the ranks 202, 204, 206, and 208 has multiple pins that can each be connected to a corresponding signal.

In some implementations, some pins from different ranks in FIG. 2 can be connected to a common signal. For example, each of the ranks 202, 204, 206, and 208 has a respective reset pin that can be connected to a common reset signal, e.g., RESET_n, such that all the four ties can be reset together.

In some implementations, each of ranks 202 and 206 that are coupled to channel A can have a respective clock pin that can be connected to one or more common clock signals, e.g., a clock true signal CK_t_A and/or a clock complement signal CK_c_A. Similarly, each of ranks 204 and 208 that are coupled to channel B can have a respective clock pin that can be connected to one or more common clock signals, e.g., a clock true signal CK_t_B and/or a clock complement signal CK_c_B. In some cases, the clock true signal and the clock complement signal connected to the same pin can form a differential pair of clock signals with opposite phases.

In some implementations, each of ranks 202 and 206 that are coupled to channel A can have a respective command/address (CA) pin (not shown in FIG. 2) that can be connected to a common CA signal, e.g., CA[5:0]_A. Similarly, each of ranks 204 and 208 that are coupled to channel B can have a respective CA pin (not shown in FIG. 2) that can be connected to a common CA signal, e.g., CA[5:0]_B, which can be different than CA[5:0]_A.

In some implementations, each of ranks 202 and 204 that are coupled to channel A and channel B respectively can have a respective impedance equalization (ZQ) pin that can be connected to a common ZQ signal, e.g., ZQ0, that is coupled to a voltage, e.g., Vddq, through an impedance, e.g., a resistor RZQ. Similarly, each of ranks 206 and 208 that are coupled to channel A and channel B respectively can have a respective impedance equalization (ZQ) pin that can be connected to a common ZQ signal, e.g., ZQ1, that is coupled to a voltage, e.g., Vddq, through an impedance, e.g., a resistor RZQ. In some cases, ZQ1 can be different than ZQ0 by using difference impedances for ZQ0 and ZQ1. Vddq can be used to provide power to output buffers of a rank.

In some implementations, each of ranks 202 and 206 that are coupled to channel A can have a respective data mask inversion (DMI) pin that can be connected to a common DMI signal, e.g., DMI[1:0]_A. Similarly, each of ranks 204 and 208 that are coupled to channel B can have a respective DMI pin that can be connected to a common DMI signal, e.g., DMI[1:0]_B, which can be different than DMI[1:0]_A.

In some implementations, each of ranks 202 and 206 that are coupled to channel A can have one or more data (DQ) pins that can be connected to one or more data signals respectively, e.g., DQ[15:0]_A. Similarly, each of ranks 204 and 208 that are coupled to channel B can have one or more data pins that can be connected to one or more data signals respectively, e.g., DQ[15:0]_B, which can be different than DQ[15:0]_A. The one or more data pins of a rank can be used to transfer data from or to the rank or a memory cell array in the rank.

In some implementations, each of ranks 202 and 206 that are coupled to channel A can have a respective data strobe (DQS) pin that can be connected to a common DQS signal, e.g., a DQS true signal DQS[1:0]_t_A or a DQS complement signal DQS[1:0]_c_A. Similarly, each of ranks 204 and 208 that are coupled to channel B can have a respective DQS pin that can be connected to a common DQS signal, e.g., a DQS true signal DQS[1:0]_t_B or a DQS complement signal DQS[1:0]_c_B, which can be different than DQS[1:0]_t_A or DQS[1:0]_c_A respectively. In some cases, the DQS true signal and the DQS complement signal connected to the same pin can form a differential pair of DQS signals with opposite phases.

In some implementations, each rank can have some pins that are each connected to a signal not shared with other pins. For example, each of ranks 202, 204, 206, and 208 can have a respective clock enable pin connected to a respective clock enable signal, e.g., CKE0_A, CKE0_B, CKE1_A, and CKE1_B respectively, to enable the aforementioned clock signals connected to clock pins in ranks 202, 204, 206, and 208 respectively.

In some implementations, each of ranks 202, 204, 206, and 208 can have a respective chip select (CS) pin connected to a respective CS signal, e.g., CS0_A, CS0_B, CS1_A, and CS1_B respectively, to select and enable each of ranks 202, 204, 206, and 208 respectively, such that the selected and enabled rank can connect to a host device (e.g., host 110 in FIG. 1A or 1B) that sends the CS signal, and perform one or more operations, e.g., read or write operations that are instructed by the host device. In some cases, the one or more operations can be performed based on the aforementioned command/address signals.

In some implementations, rank 202 can have an on-die termination of command/address signals (ODT_CA) pin that can be connected to an ODT_CA signal, e.g., ODT_CA_A. Similarly, rank 204 can have an ODT_CA pin that can be connected to an ODT_CA signal, e.g., ODT_CA_B, which can be different than ODT_CA_A. In some cases, ODT_CA_A and ODT_CA_B can be used for on-die termination (ODT) of the aforementioned CA signals CA[5:0]_A and CA[5:0]_B respectively.

In some implementations, rank 206 can have an ODT_CA pin that can be connected to a voltage Vss. Similarly, rank 208 can have an ODT_CA pin that can be connected to a voltage Vss. In some cases, Vss can be used to provide a ground connection to a die.

FIG. 3 illustrates an example memory apparatus 300 including multiple ranks associated with a same channel. The memory apparatus 300 can be implemented as the memory package 125 of FIG. 1A, or the memory group 125a or 125b of FIG. 1B. The memory apparatus 300 can be configured to perform rank-related operations, e.g., by a controller (e.g., the memory controller 122 of FIG. 1A or 1B) coupled to the memory apparatus 300.

In some implementations, e.g., as shown in FIG. 3, multiple first ranks, e.g., six ranks 302a, 302b, 302c, 302d, 302e, and 302f (referred to generally as ranks 302 and individually as rank 302) are connected to the same channel (also referred to as a first channel), e.g., the first channel 124a in FIG. 1B. Each rank 302 can be similar to or same as the rank 126 of FIG. 1A or 1B or the rank 202, 204, 206, 208 of FIG. 2. Multiple signals, for example, clock true signal CK_t, clock complement signal CK_c, command/address signal CA[5:0], data strobe true signal DQS[1:0]_t, data strobe complement signal DQS[1:0]_c, and data signal DQ[15:0], can each be received through the corresponding pins in the six ranks by the six ranks in the same channel in FIG. 3. That is, the multiple signals are shared by all the six ranks in the same channel. In some cases, data can be transferred to and from the six ranks through the first channel.

In some implementations, a common rank select signal (e.g., a second signal) shared by and connected to all six ranks, for example, CS_all, can be received through corresponding pins (e.g., a second pin) in the six ranks to select the six ranks together. Once selected, the six ranks can be connected to a host device (e.g., host 110 in FIG. 1A or 1B) through the channel that is coupled to the six ranks. In some cases, the host device selects the six ranks coupled to the first channel using the rank select signal, while not sending rank select signals to any ranks in any other channels coupled to the host device. In some cases, at a given time, only ranks coupled to one channel in a memory system can be selected by the host device using a rank select signal.

In some implementations, each of the six ranks can receive a respective signal (also referred to as a rank enable signal or a first signal) through a corresponding pin (e.g., a first pin) in the rank for enabling the rank, for example, CS_0, CS_1, CS_2, CS_3, CS_4, and CS_5 for enabling rank 302a, 302b, 302c, 302d, 302e, and 302f respectively. In some cases, one or more ranks (e.g., one or more first ranks) in the six ranks can be enabled together, using one or more rank enable signals (e.g., one or more first signals) sent to the one or more corresponding ranks. In some cases, the one or more first signals are different than the second signal.

After the rank select signal CS_all is received by the six ranks and one or more rank enable signals of CS_0 to CS_5 are received by one or more ranks of the six ranks, the one or more ranks that have been enabled according to the one or more rank enable signals and selected according to the rank select signal CS_all can perform one or more operations, e.g., read and/or write operations that are instructed by the host device. In some cases, CS_all can be sent from the host device. In some cases, the one or more operations can be performed sequentially on the one or more ranks or in parallel on the one or more ranks, depending on the one or more rank enable signals. For example, a respective rank enable signal in the one or more rank enable signals can be applied sequentially to each of the one or more ranks, while the rank select signal CS_all is applied to all six ranks, such that the one or more ranks can perform their operations sequentially. In another example, the one or more rank enable signals can be applied in parallel to the one or more ranks, while the rank select signal CS_all is applied to all six ranks, such that the one or more ranks are enabled together and can perform their operations in parallel.

In some implementations, the one or more operations can include a sequential operation that includes rank-specific training or data read out.

In some implementations, the one or more operations can include an in-parallel operation that includes computing or data inputting.

In some implementations, a clock enable signal shared by and connected to all six ranks, for example, CKE, can be used to enable and synchronize clock signals across the six ranks.

In some implementations, the CA signal received by a rank, for example, CA[5:0]_A or CA[5:0]_B, can be decoded based on the rank select signal CS_all. The CA signal can be synchronized based on the DQS signal (e.g., DQS[1:0]_t and/or DQS[1:0]_c) and the clock signal (e.g., CK_c). A rank in FIG. 3 can be operated based on the CA signal and the data signal (e.g., DQ[15:0]) received by the rank.

In some implementations, a second channel, e.g., the second channel 124b in FIG. 1B, which is different than the first channel that is coupled to the six ranks in FIG. 3, can be coupled to the host device that is also coupled to the first channel. The second channel can be coupled to a second set of ranks (e.g., a plurality of second ranks) that are different than the six ranks in FIG. 3. In some cases, data can be transferred to and from the second set of ranks through the second channel.

In some implementations, one or more ranks in the second set of ranks can be enabled to perform one or more operations in a manner similar to that described above for enabling one or more ranks in the six ranks in FIG. 3, using a rank select signal (e.g., a third signal) similar to CS_all in FIG. 3, and one or more rank enable signals, similar to the one or more rank enable signals of CS_0 to CS_5 in FIG. 3.

For example, a common rank select signal (e.g., a third signal) shared by and connected to the second set of ranks can be received through corresponding pins in the second set of ranks to select the second set of ranks together. Once selected, the second set of ranks can be connected to the host device (e.g., host 110 in FIG. 1A or 1B) through the second channel that is coupled to the second set of ranks. In some cases, the host device selects the second set of ranks coupled to the second channel using the third signal, while not sending rank select signals to any ranks in any other channels coupled to the host device (e.g., the six ranks coupled to the first channel).

In some implementations, each of the second set of ranks can receive a respective rank enable signal through a corresponding pin in the rank for enabling the rank. In some cases, one or more ranks (e.g., one or more second ranks) in the second set of ranks can be enabled together, using one or more rank enable signals (e.g., one or more fourth signals) sent to the one or more ranks in the second set of ranks.

After the common rank select signal is received by the second set of ranks and one or more rank enable signals are received by the one or more ranks of the second set of ranks, the one or more ranks that have been enabled according to the one or more rank enable signals and selected according to the common rank select signal can perform one or more operations, e.g., read or write operations that are instructed by the host device. In some cases, the common rank select signal can be sent from the host device. In some cases, the one or more operations can be performed sequentially on the one or more ranks or in parallel on the one or more ranks, depending on the one or more rank enable signals. For example, a respective rank enable signal in the one or more rank enable signals can be applied sequentially to each of the one or more ranks, while the common rank select signal is applied to the second set of ranks, such that the one or more ranks can perform their operations sequentially. In another example, the one or more rank enable signals can be applied in parallel to the one or more ranks, while the common rank select signal is applied to the second set of ranks, such that the one or more ranks in the second set of ranks are enabled together and can perform their operations in parallel.

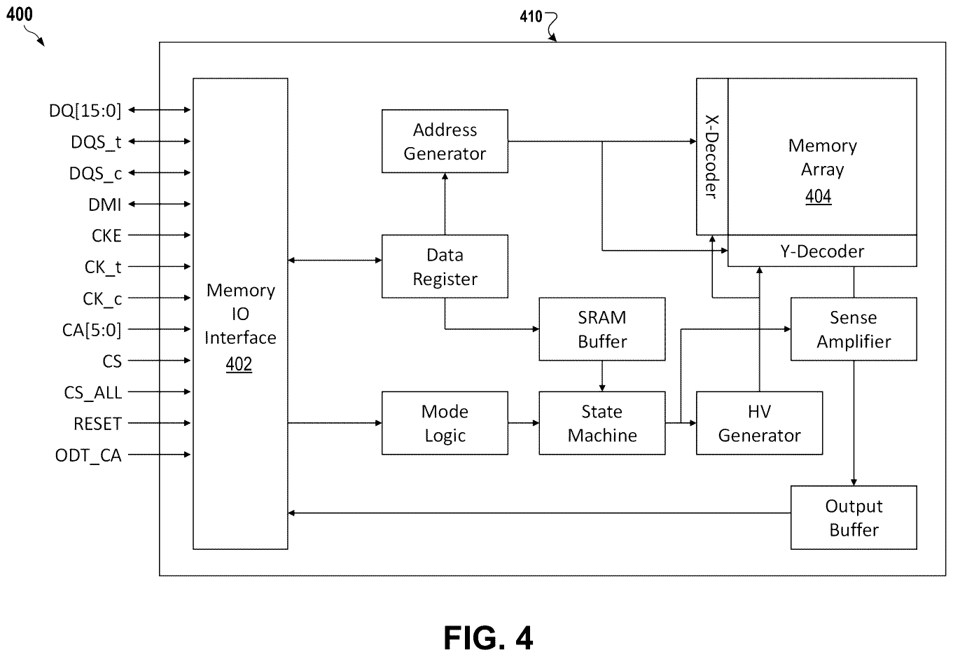

FIG. 4 illustrates an example memory device 400 in a memory rank. The memory rank can be, e.g., the rank 126 of FIG. 1A or 1B, the rank 202, 204, 206, or 208 of FIG. 2, or the rank 302 FIG. 3.

As shown in FIG. 4, the memory device 400 has multiple pins coupled to a memory input/output (I/O) interface 402 in the memory device 400. Each of the multiple pins can be coupled to a signal. The multiple pins can include a rank select pin (e.g., a second pin) that can receive a rank select signal (e.g., a second signal), such as CS_all, to select the memory device. The multiple pins also include a rank enable pin (e.g., a first pin) that can receive a rank enable signal (e.g., a first signal), such as CS, to enable the memory device to perform one or more operations. The multiple pins and the signals coupled to the multiple pins can be same as, or similar to, the pins as described with details in FIG. 2 and FIG. 3.

The memory device 400 also includes a memory array 404 (also referred to as a memory cell array). Components of the memory device 400 (e.g., memory I/O interface 402), excluding the memory array 404, are part of a peripheral circuit 410 that can be coupled to the memory array 404. As shown in FIG. 4, the peripheral circuit 410 can include, but not limited to, an address generator, a data register, an SRAM buffer, a state machine, a mode logic, a high voltage (HV) generator, a page buffer circuit or a sense amplifier, an X-decoder, a Y-decoder, and an output buffer.

In some implementations, the peripheral circuit 410 can be configured to receive the rank select signal (e.g., CS_all) at the rank select pin to select the memory device 400, receive the rank enable signal (e.g., CS) at the second pin to enable the memory device 400, where the rank enable signal is different than the rank select signal. The peripheral circuit 410 can be configured to: in response to receiving the rank select signal and the rank enable signal, enable the memory device to perform the one or more operations on the memory array 404.

In some implementations, the peripheral circuit 410 can be configured to receive the rank select signal to select the memory device 400, while the memory device 400 is disabled. For example, one or more other memory devices in a same channel as the memory device 400 can be selected by the same rink select signal and also enabled by individual rank enable signals.

In some implementations, the peripheral circuit 410 can be configured to receive a command/address (CA) signal that is different from the rank select signal and the rank enable signal, decode the CA signal based on the rank select signal, and perform the one or more operations on the memory array 404 based on the CA signal.

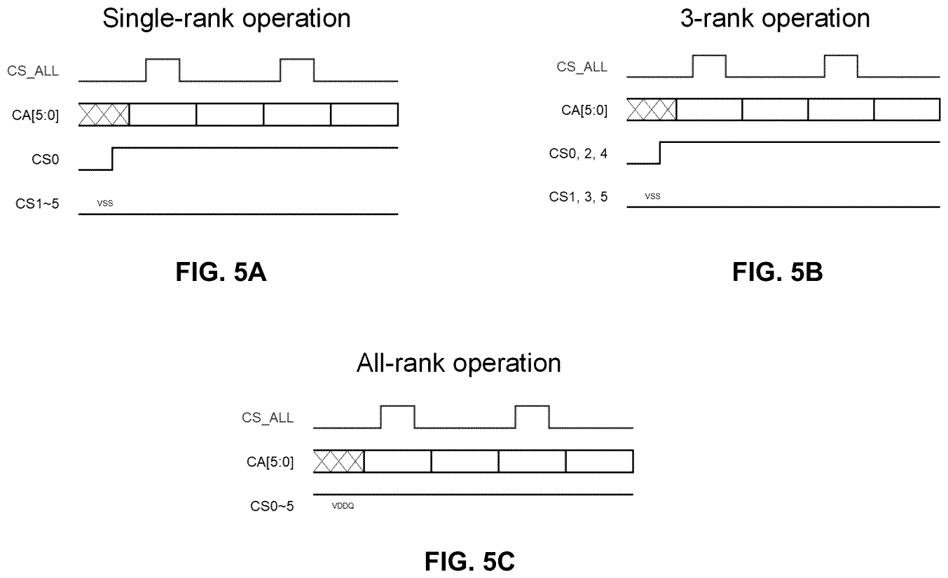

FIGS. 5A to 5C illustrate three example operations of enabling one or more ranks in a memory system to perform one or more operations. In some implementations, the memory system can be memory system 120 in FIG. 1A or 1B. The one or more ranks can be the ranks 126 of FIG. 1A or 1B, the ranks 302 of FIG. 3. The one or more ranks can be in a same package, e.g., the memory package 125 of FIG. 1A or the memory group 125a, 125b of FIG. 1B, or the memory apparatus 300 of FIG. 3. Each rank can include a memory device, e.g., the memory device 400 of FIG. 4. The signals in FIGS. 5A to 5C can be same as or similar to the signals as described in FIG. 2 and/or FIG. 3.

As shown in FIGS. 5A to 5C, a rank select signal CS_all (e.g., a second signal) is applied to six ranks coupled to a channel in the memory system, for example, the six ranks in FIG. 3, to select the six ranks. The rank select signal can include one or more pulses that include alternating higher levels and lower levels.

As shown in FIGS. 5A to 5C, a command/address (CA) signal CA[5:0] is applied to the six ranks. In some implementations, the CA signal can be decoded based on the rank select signal CS_all. The one or more operations can be performed on the six ranks (or memory arrays in the six ranks) based on the CA signal.

In some implementations, to enable one or more ranks in the six ranks to perform the one or more operations, one or more rank enable signals (e.g., a first signal), for example, one or more of CS0 to CS5, can be used.

For example, as shown in FIG. 5A, to enable only one rank, for example, rank 302 in FIG. 3, a rank enable signal CS0 (also referred to as CS_0 in FIG. 3) can be received by the rank, e.g., rank 302a. In some cases, the rank enable signal CS0 can include a step signal from a lower level to a higher level or from a higher level to a lower level. All other rank enable signals, e.g., CS1 to CS5, remain at Vss.

As shown in FIG. 5B, to enable only three ranks, for example, rank 302a, 302c, and 302e in FIG. 3, three rank enable signals CS0, CS2, and CS4 (also referred to as CS_0, CS_2, and CS_4 respectively in FIG. 3) can be received by the three ranks, e.g., ranks 302a, 302c, and 302e, respectively. In some cases, each of the rank enable signals CS0, CS2, and CS4 can include a step signal from a lower level to a higher level or from a higher level to a lower level. All other rank enable signals, e.g., CS1, CS3, and CS5, coupled to the other ranks, e.g., rank 302b, 302d, 302f, remain at Vss.

As shown in FIG. 5C, to enable all six ranks, for example, ranks 302a, 302b, 302c, 302d, 302e, 302f in FIG. 3, all rank enable signals CS0 to CS5 (also referred to as CS_0 to CS_5 respectively in FIG. 3) can be received by the six ranks respectively. In some cases, each of the rank enable signals CS0 to CS5 can include a step signal from a lower level to a higher level or from a higher level to a lower level. No rank enable signals remain at Vss.

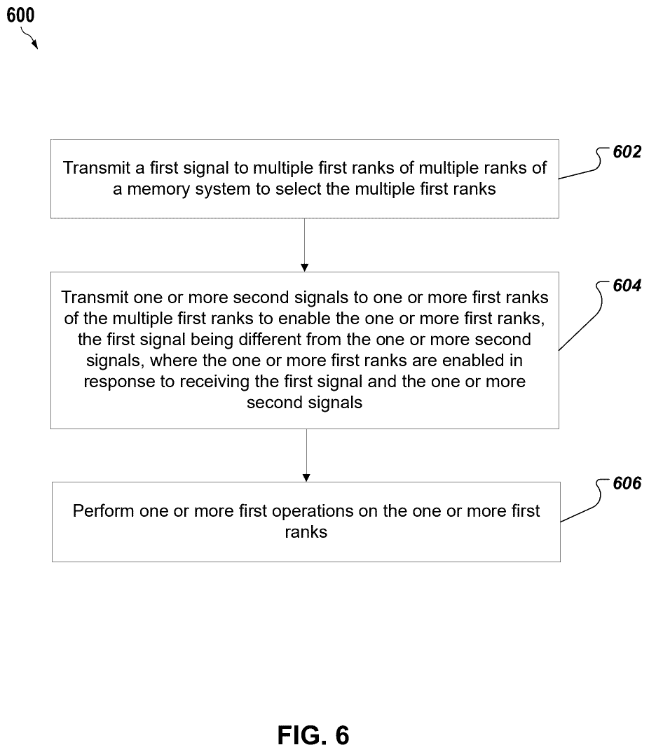

FIG. 6 is a flowchart of an example process 600 of performing multi-rank operations in a memory system. The memory system can be the memory system 120 of FIG. 1A or 1B. The memory system can include multiple ranks and a memory controller coupled to the multiple ranks. The memory controller can be, e.g., the memory controller 122 of FIG. 1A or 1B. A rank can be, e.g., the rank 126 of FIG. 1A or 1B, one of the ranks 202 to 208 in FIG. 2, or one of the ranks 302 in FIG. 3. Each of the multiple ranks can include at least one memory device, e.g., the memory device 400 of FIG. 4. The multiple ranks can be in a same package, e.g., the memory package 125 of FIG. 1A or 1B, the memory group 125a, 125b of FIG. 1B, or the memory apparatus 300 of FIG. 3.

At step 602, the memory controller transmits one or more first signals (e.g., one or more of rank enable signals CS_0 to CS_5 in FIG. 3 or FIG. 5) to one or more first ranks (e.g., one or more ranks of ranks 302 in FIG. 3) of multiple first ranks (e.g., in the memory group 125a of FIG. 1B or in the memory apparatus 300 of FIG. 3) of the multiple ranks to enable the one or more first ranks.

At step 604, the memory controller transmits a second signal (e.g., a rank select signal CS_all) to the multiple first ranks (e.g., ranks 302 in FIG. 3) to select the multiple first ranks, where the second signal is different from the one or more first signals, and the one or more first ranks are enabled in response to receiving the one or more first signals and the second signal.

At step 606, the memory controller performs one or more first operations on the one or more first ranks.

In some implementations, a number of the one or more first ranks is identical to or smaller than a number of the multiple first ranks.

In some implementations, the at least one memory device (e.g., the memory device in FIG. 4) includes a synchronous dynamic random-access memory (SDRAM).

In some implementations, the second signal is transmitted to each of the multiple first ranks, and each of the one or more first ranks is configured to receive a respective first signal of the one or more first signals.

In some implementations, each of the one or more first ranks includes an interface (e.g., memory I/O interface 402 of FIG. 4) having a first pin (e.g., the pin for CS in FIG. 4) for receiving the respective first signal and a second pin (e.g., the pin for CS_all in FIG. 4) for receiving the second signal, the second pin being different from the first pin.

In some implementations, the interface has one or more other pins including at least one of a clock pin for receiving a clock signal (e.g., CK_t or CK_c in FIG. 4), one or more data pins for transferring data (e.g., DQ[15:0] in FIG. 4) from or to the memory cell array, a reset pin (e.g., the pin for RESET in FIG. 4) for resetting the memory device, a clock enable (CKE) pin (e.g., the pin for CKE in FIG. 4) for enabling the clock signal, a data mask inversion (DMI) pin (e.g., the pin for DMI in FIG. 4), a command/address (CA) pin for receiving a command/address input (e.g., CA[5:0] in FIG. 4), or a data strobe (DQS) pin (e.g., the pin for DQS_t or DQS_c in FIG. 4) for synchronizing a timing of data transmission.

In some implementations, the memory controller includes multiple interface pins respectively coupled to corresponding pins of the interface of each of the multiple first ranks, the corresponding pins including the first pin, the second pin, and the one or more other pins.

In some implementations, second pins (e.g., one or more of pins for CS_all in FIG. 3) of the multiple first ranks are coupled together to receive the second signal, and first pins (e.g., one or more of pins for CS_0 to CS_5 in FIG. 3) of the multiple second ranks are independent from each other and configured to respectively receive corresponding first signals.

In some implementations, the memory controller transmits one or more other signals including a clock signal (e.g., CK_t or CK_c in FIG. 4), a clock enable signal (e.g., CKE in FIG. 4), a data signal (e.g., DQ[15:0] in FIG. 4), a data mask inversion (DMI) signal (e.g., DMI in FIG. 4), a command/address (CA) signal (e.g., CA[5:0] in FIG. 4), and/or a data strobe (DQS) signal (e.g., DQS_t or DQS_c in FIG. 4), to each of the multiple first ranks, where the one or more other signals are different from the one or more first signals and the second signal.

In some implementations, each of the one or more first ranks is configured to perform at least one of decoding the CA signal based on the first signal, synchronizing the CA signal based on the DQS signal and the clock signal, or operating a corresponding memory device (e.g., the memory device in FIG. 4) of the rank based on the data signal and the CA signal.

In some implementations, the memory controller performs the one or more first operations sequentially on the one or more first ranks, or performs the one or more first operations in parallel on the one or more first ranks.

In some implementations, the one or more first operations include a sequential operation including rank-specific training or data read out, or an in-parallel operation including computing or data inputting.

In some implementations, the second signal (e.g., CS_all in FIG. 5) includes a higher signal level and a lower signal level that alternate over time, and each of the one or more first signals includes a step signal.

In some implementations, the multiple first ranks are associated with a first channel (e.g., first channel 124a in FIG. 1A), and the multiple ranks include multiple second ranks that are associated with a second channel (e.g., second channel 124b in FIG. 1B) different from the first channel, and the multiple second ranks are different from the multiple first ranks, and are coupled to the circuitry. The multiple second ranks can be, e.g., in the memory group 125b of FIG. 1B or in the memory apparatus 300 of FIG. 3.

In some implementations, the memory controller transfers data (e.g., DQ[15:0] in FIG. 3) to or from the multiple first ranks through the first channel.

In some implementations, the memory controller transfers data to or from the multiple second ranks through the second channel.

In some implementations, the memory controller transmits the second signal to the multiple first ranks to select the multiple first ranks, without transmitting a third signal (e.g., a rank select signal) to the multiple second ranks to select the multiple second ranks.

In some implementations, the memory controller transmits the third signal to the multiple second ranks, without transmitting the first signal to the multiple first ranks.

In some implementations, the memory controller transmits the third signal to each of the multiple second ranks.

In some implementations, the memory controller transmits one or more fourth signals (e.g., rank enable signals) respectfully to one or more second ranks of the multiple second ranks to enable the one or more second ranks, where each of the one or more second ranks is enabled to perform one or more second operations in response to receiving the third signal and a corresponding fourth signal of the one or more fourth signals.

In some implementations, the memory controller is coupled to a host device (e.g., host 110 in FIG. 1A or 1B), and the memory controller receives the second signal from the host device to select the multiple first ranks to connect with the host device through a first channel.

In some implementations, the memory controller receives the one or more first signals from the host device to enable the one or more first ranks for the one or more first operations.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, flash memory devices, and magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. An apparatus, comprising:
a plurality of ranks, wherein each of the plurality of ranks comprises at least one memory device,
wherein one or more first ranks of a plurality of first ranks of the plurality of ranks are configured to be enabled based on one or more first signals,
wherein the plurality of first ranks are configured to be selected based on a second signal that is different from the one or more first signals, and
wherein the one or more first ranks are configured to perform one or more first operations in response to receiving the one or more first signals and the second signal.

2. The apparatus of claim 1, wherein each of the plurality of first ranks is configured to receive the second signal, and each of the one or more first ranks is configured to receive a respective first signal of the one or more first signals.

3. The apparatus of claim 2, wherein each of the one or more first ranks comprises an interface having a first pin for receiving the respective first signal and a second pin for receiving the second signal, the second pin being different from the first pin.

4. The apparatus of claim 3, wherein the interface of each of the one or more first ranks has one or more other pins comprising at least one of:
a clock pin for receiving a clock signal,
one or more data pins for transferring data from or to a memory cell array,
a reset pin for resetting the first rank,
a clock enable (CKE) pin for enabling the clock signal,
a data mask inversion (DMI) pin,
a command/address (CA) pin for receiving a command/address input, or
a data strobe (DQS) pin for synchronizing a timing of data transmission.

5. The apparatus of claim 4, wherein the interface of each of the plurality of first ranks is coupled to a controller through corresponding pins, the corresponding pins comprising the first pin, the second pin, and the one or more other pins.

6. The apparatus of claim 3, wherein second pins of the plurality of first ranks are coupled together to receive the second signal, and first pins of a plurality of second ranks are independent from each other and configured to respectively receive corresponding first signals.

7. The apparatus of claim 1, wherein each of the plurality of first ranks is configured to:
receive one or more other signals comprising a clock signal, a clock enable signal, a data signal, a data mask inversion (DMI) signal, a command/address (CA) signal, and a data strobe (DQS) signal,
wherein the one or more other signals are different from the second signal and the one or more first signals.

8. The apparatus of claim 7, wherein each of the one or more first ranks is configured to perform at least one of
decoding the CA signal based on the second signal,
synchronizing the CA signal based on the DQS signal and the clock signal, or
operating a corresponding memory device of the rank based on the data signal and the CA signal.

9. The apparatus of claim 1, wherein the one or more first ranks are configured to:
perform the one or more first operations sequentially, or
perform the one or more first operations in parallel.

10. The apparatus of claim 9, wherein the one or more first operations comprise:
a sequential operation comprising rank-specific training or data read out, or
an in-parallel operation comprising computing or data inputting.

11. The apparatus of claim 1, wherein the second signal comprises a higher signal level and a lower signal level that alternate over time, and each of the one or more first signals comprises a step signal.

12. The apparatus of claim 1, wherein the plurality of first ranks are associated with a first channel, and the plurality of ranks comprise a plurality of second ranks that are associated with a second channel different from the first channel, and
wherein the plurality of second ranks are different from the plurality of first ranks.

13. The apparatus of claim 12, wherein the plurality of ranks are coupled to a controller, and
wherein the plurality of first ranks are configured to transfer data to or from the controller through the first channel, and wherein the plurality of second ranks are configured to transfer data to or from the controller through the second channel.

14. The apparatus of claim 12, wherein the plurality of ranks are configured to:
receive the second signal by the plurality of first ranks to select the plurality of first ranks, without receiving a third signal to the plurality of second ranks to select the plurality of second ranks, and
receive the third signal to the plurality of second ranks to select the plurality of second ranks, without receiving the second signal to the plurality of first ranks to select the plurality of first ranks.

15. The apparatus of claim 14, wherein each of the plurality of second ranks is configured to receive the third signal,
wherein one or more second ranks of the plurality of second ranks are configured to receive one or more fourth signals respectfully to enable the one or more second ranks, and
wherein each of the one or more second ranks is enabled to perform one or more second operations in response to receiving the third signal and a corresponding fourth signal of the one or more fourth signals.

16. A memory device, comprising:
a memory cell array; and
a peripheral circuit coupled to the memory cell array, the peripheral circuit comprising an interface having a first pin and a second pin, the second pin being different from the first pin,
wherein the peripheral circuit is configured to:
receive a first signal at the first pin to enable the memory device;
receive a second signal at the second pin to select the memory device, wherein the second signal is different than the first signal; and
in response to receiving the first signal and the second signal, enable the memory device to perform one or more operations on the memory cell array.

17. The memory device of claim 16, wherein the interface further comprises at least one of:
a clock pin for receiving a clock signal,
one or more data pins for transferring data from or to the memory cell array,
a reset pin for resetting the memory device,
a clock enable (CKE) pin for enabling the clock signal,
a data mask inversion (DMI) pin,
a command/address (CA) pin for receiving a command/address input, or
a data strobe (DQS) pin for synchronizing a timing of data transmission.

18. The memory device of claim 16, wherein the peripheral circuit is configured to receive the second signal to select the memory device, while the memory device is disabled.

19. The memory device of claim 16, wherein the peripheral circuit is configured to:
receive a command/address (CA) signal that is different from the first signal and the second signal;
decode the CA signal based on the second signal; and
perform the one or more operations on the memory cell array based on the CA signal.

20. A method, comprising:
receiving, by one or more first ranks of a plurality of first ranks of a plurality of ranks, one or more first signals to enable the one or more first ranks;
receiving, by the plurality of first ranks, a second signal to select the plurality of first ranks, the second signal being different from the one or more first signals, wherein the one or more first ranks are enabled in response to receiving the one or more first signals and the second signal; and
performing, by the one or more first ranks, one or more first operations.
